(19) United States
(12) Patent Application Publication
(10) Pub. No.: US 2006/0019682 A1
(43) Pub. Date: Jan. 26, 2006

(54) Apparatus for improving communication quality of PHS handset and method thereof

(75) Inventors: Cheng-Shing Lai, Taipei Hsien (TW); Cui Qi, Nanking (CN); Yong-Cai Bian, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/893,943

(22) Filed: Jul. 20, 2004

(51) Int. Cl. H04Q 7/20; H04M 11/00

(52) U.S. Cl. 455/465; 455/403

(57) ABSTRACT

The present invention is to provide an apparatus for improving communication quality of PHS handset and method thereof, which enables any two PHS handsets to be extensions and communicate directly by utilizing a fixed private telephone or a fixed public telephone having a wireless communication exchange module as a main telephone, so that the PHS handsets are able to not only communicate directly therebetween but also make or receive a call through the connections among the fixed telephones and operate normally in an environment without having the external cell stations.

### FIELD OF THE INVENTION

The present invention relates to PHS (Personal Handyphone System), and more particularly to an apparatus for improving communication quality of PHS handset and method thereof, enabling any two PHS handsets to communicate directly by utilizing a private fixed telephone or a public fixed telephone having a wireless communication exchange module and operate normally in an environment without having external cell stations.

### BACKGROUND OF THE INVENTION

Both PHS and GSM (Global System for Mobile) are wireless communication systems. But PHS was developed in 1995 by Japan while GSM was developed by European Union. PHS is a low power cellular phone system having a low operating frequency. Each of a great number of micro cell stations employed by PHS has an effective signal transmission distance of 100 meters to 300 meters. PHS can be implemented in smaller, lighter cellular phones due to low operating power. Such advantage enables PHS to perform better than GSM with respect to the period of communication time and standby time. PHS has the following applications:

(i) Indoor cordless telephone extension. A user can install a main telephone complying with a-PHS and a PHS handset as a cordless extension of the main telephone.

(ii) Wireless mobile communication. A PHS handset can be used as a typical cellular phone. Further, a PHS handset has the feature of high data transmission rate in addition to the features of sound signal transmission and receiving as found in typical cellular phones.

(iii) Mobile office cordless phone. A PHS handset can operate in cooperation with a digital exchange as a multifunctional cordless phone in an office.

(iv) Direct communication between PHS handsets. Two PHS handsets even can talk each other directly without the involvement of a cell station in a short distance. Such can greatly reduce the amount of telecommunication bill. Most importantly, it is particularly suitable for rescue operations in an area affected by disaster.

A WLL (Wireless Local Loop) system typically comprises wireless terminals (or limited user end equipment) and cell stations. An exchange transfer system comprises a remote exchange, a DLC (Digital Loop Carrier), concentrators (or multiplexors), etc. depending on different systems. PHS can effect a full duplex wireless communication between a main telephone and an extension as implemented in WLL system. Either main telephone or extension occupies a wireless channel. Currently, bandwidth allotted to analog wireless communication is narrow throughout the world. As such, the number of channel is limited and the capacity in use is limited. Thus, it is typical that either a PHS handset in use may be interfered by another PHS handset in a short distance due to high density of PHS handsets or a PHS handset owned by someone being used by an unauthorized person.

CAI (Common Air Interface) of PHS is stipulated by Wireless System Development Center of Japan. CAI specifies features regarding two PHS handsets involved in wireless communication. CAI comprises three categories including a wireless interface for specifying details or operating instructions of data modulation and carrier, three signal levels, and a voice encoding and transmission scheme.

PHS has an operating frequency of 1,895 MHz to 1,918.1 MHz and specific control channels in which 40 channels of low frequency are for home or office applications and the remaining 37 channels are for public communication. PHS uses a public network such as PSTN (Public Switched Telephone Network) or ISDN (Integrated Services Digital Network) as trunk for system interconnection. For example, PHS has a voice channel transmission rate up to 32 Kbit/s if PHS is coupled to ISDN.

PHS handsets are convenient, portable phones and are gaining popularity recently due to technological advancements, the promotion by major telephone companies, and low cost and fee. Further, a certain portion of mobile communication market is owned by PHS. However, the most significant drawback of PHS is its short communication distance. Despite of rather low installation cost of cell stations of PHS as compared with that of typical cellular phone system, an effective coverage of a cell station of PHS is much smaller than that of the typical cellular phone system.

A cell station of PHS has a power in the range of 20 mW to 500 mW in which coverage of 20 mW is about 100 meters and coverage of 500 mW is about 500 meters. In comparison, a base station of the typical cellular phone system has a coverage in the range of several kilometers to several tens kilometers which is much larger than that of the cell station of PHS. As such, a great number of cell stations are required to install in a small area (i.e., densely populated cell stations) in an outdoor environment for increasing the coverage. However, it is still often that a PHS handset user cannot communicate well in an indoor environment due to much weak signal strength. Such drawback has reduced the enthusiasm of using PHS handsets by users to a certain level. Moreover, communication quality of a PHS handset in a high speed moving vehicle is rather low. In fact, PHS handsets are not designed as an effective communication tool in a high speed moving vehicle. A delay can occur when signal is sent between two cell stations (i.e., disconnected). Thus, it is desirable among the art to provide means for improving communication quality of PHS handset in order to overcome the above drawbacks of the prior art.

### SUMMARY OF THE INVENTION

The present invention is to provide means for communicating directly among PHS handsets. That is, two PHS handsets are able to communicate directly without the involvement of CSs (cell stations). It requires all terminals (e.g., PSs (PHS handsets)) to register in a group in which one of the PSs is served as a main telephone and other remaining PSs are served as extensions. All PSs including the main telephone and the extensions are able to communicate directly therebetween.

A primary object of the present invention is to provide an apparatus for improving communication quality of PHS handset and method thereof wherein a PHS handset is able to operate normally not only when signals through external CSs are sufficiently strong but also in an environment without the external cell stations. Moreover, the present invention enables any two PHS handsets to communicate directly by utilizing one of the PHS handsets as a main telephone and other remaining PHS handsets as extensions so that all PHS handsets are able to not only communicate directly therebetween but also make or receive a call through the connections among the fixed telephones and an external fixed telephone network such as PSTN. By utilizing the present invention, the above drawback of weak signal in an indoor environment as experienced by the prior art can be overcome.

The above and other objects, features and advantages of the present invention will become apparent from the following detailed description taken with the accompanying drawings.

### BRIEF DESCRIPTION OF THE DRAWINGS

FIG. 1 is a schematic block diagram of the invention;

FIG. 2 is a first flow chart of the invention;

FIG. 3 is a second flow chart of the invention;

FIG. 4 is a third flow chart of the invention;

FIG. 5 is a fourth flow chart of the invention; and

FIG. 6 is a fifth flow chart of the invention.

### DETAILED DESCRIPTION OF THE PREFERRED EMBODIMENTS

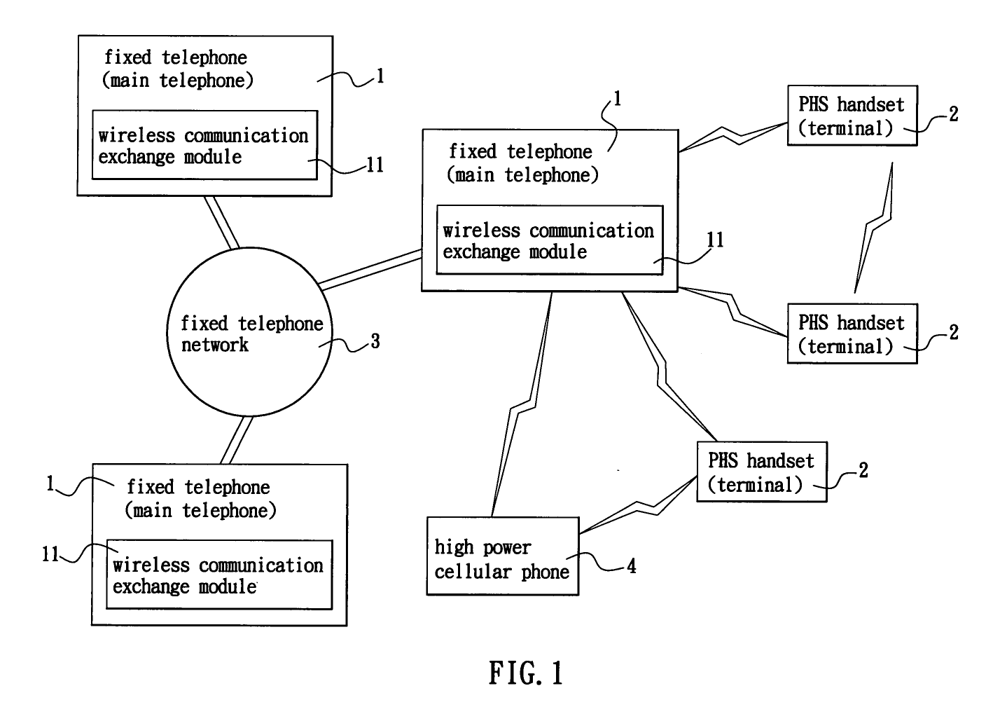

Referring to FIG. 1, there is shown an apparatus for improving communication quality of PHS handset and method thereof in accordance with the invention. The method is implemented in a fixed public switched exchange type telephone network (i.e., widely referred to a fixed telephone network 3 involved telecommunication infrastructure including a variety of twisted pair telephone networks such as PSTN). Each of all fixed telephones 1 (e.g., personal telephones or public telephones) has a wireless communication exchange module 11 associated with the fixed telephone network 3. By configuring as above, not only the fixed telephone 1 can be used as a typical communication means. Further a low power cellular phone (e.g., PHS handset) 2 can use an adjacent fixed telephone 1 as a CS (cell station) for communicating with any PHS handset 2 or high power cellular phone (e.g., GSM handset) 4 via the fixed telephone 1 when the PHS handset 2 is not able to communicate wirelessly in certain circumstances (e.g., weak signal, out of the coverage, etc.) Alternatively, the PHS handset 2 may communicate through connections among the fixed telephone network 3 and the fixed telephones 1.

Referring to FIG. 1 again, in the invention the fixed telephone 1 comprises a wireless communication exchange module 11 in cooperation with the PHS handset 2. Thus, not only the fixed telephone 1 can be served as a PHS handset 2 but also the fixed telephone 1 can be served as a base. The base is in turn coupled to an external fixed telephone network 3 (e.g., PSTN). The PHS handset 2 can be served as a terminal which not only is able to convey messages and sound to any terminal (e.g., any of other PHS handsets 2) via a wireless channel but also is able to connect to the wireless communication exchange module 11 of the fixed telephone 1 such that the fixed telephone 1 can be used as an exchange for other PHS handsets 2 and high power cellular phones (e.g., GSM handsets) 4 or for other fixed telephones 1 in communication.

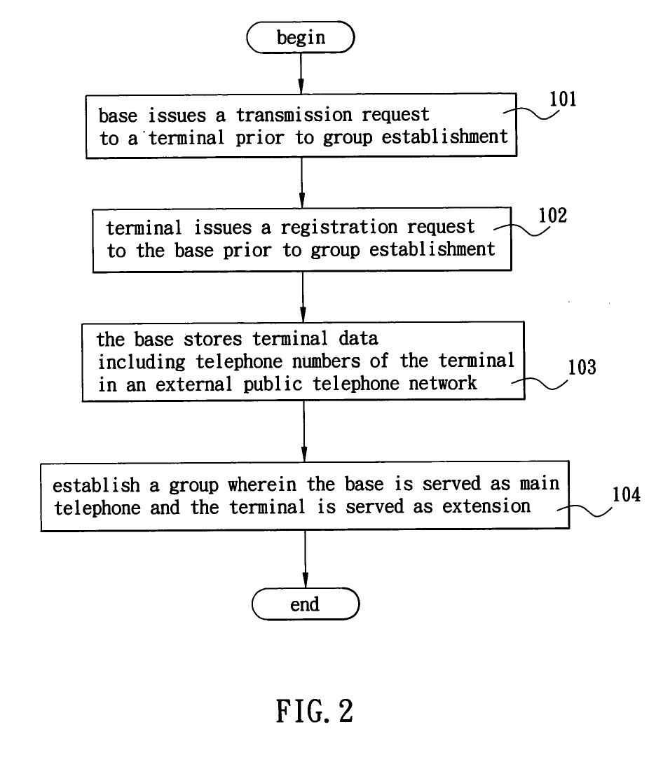

However, prior to the completion of the above, it requires all PHS handsets 2 and the fixed telephones 1 having the wireless communication exchange module 11 to register in a group in which one fixed telephone 1 is served as a main telephone and other remaining PHS handsets 2 are served as extensions. As to how to register in a group and how to communicate directly between two PHS handsets 2 are not described further since they are well known. Following will describe how to connect a base to a terminal prior to the establishment of a group by referring to a flow chart in FIG. 2.

In step 101, a base issues a transmission request to a terminal prior to establishing a group (i.e., main telephone).

In step 102, the terminal issues a registration request to the base prior to establishing a group (i.e., extension).

In step 103, the base stores terminal data including telephone numbers of the terminal in an external public telephone network.

In step 104, a group is established in which the base is served as a main telephone and the terminal is served as an extension.

In the above steps, a plurality of low power cellular phones (e.g., PHS handsets) 2 are also installed as extensions in the process of establishing a group by means of base. Thus, any desired number of PHS handsets 2 can be installed by repeating the steps 101 to 104.

In the invention for terminal and base a connection can be established in a called state or calling state as detailed below.

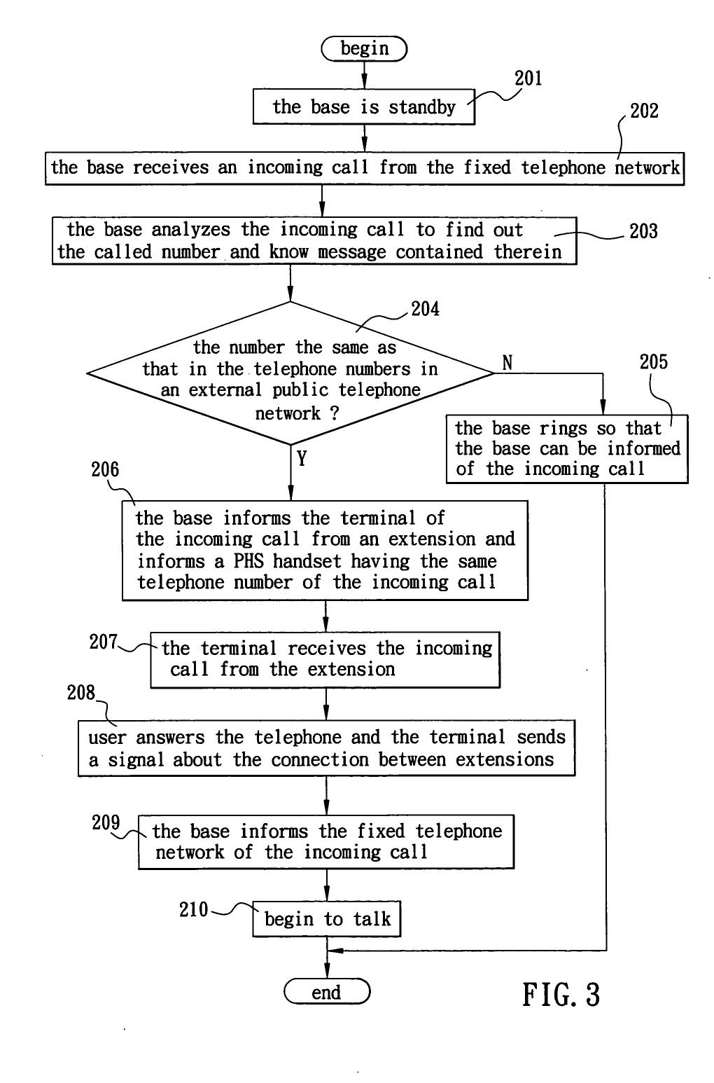

(i) Details of transferring an incoming call to a terminal from a base are illustrated in the flow chart of FIG. 3.

In step 201, the base is in a standby state.

In step 202, the base receives an incoming call from the fixed telephone network 3.

In step 203, the base analyzes the incoming call to find out the called number and know message contained therein.

In step 204, search terminal data including telephone numbers of the terminal in an external public telephone network and compare the same with the called number. If there is a match, the process jumps to step 206. Otherwise, the process goes to step 205.

In step 205, the base rings so that the base can be informed of the incoming call.

In step 206, the base informs the terminal of the incoming call from an extension and informs a PHS handset having the same telephone number of the incoming call.

In step 207, the terminal receives the incoming call from the extension.

In step 208, a user answers the telephone and the terminal sends a signal about the connection between extensions.

In step 209, the base informs the fixed telephone network 3 of the incoming call.

In step 210, begin to talk over the telephone.

The base is the called party and is adapted to answer the telephone if there is no match between telephone numbers of the terminal in the external public telephone network and the called number.

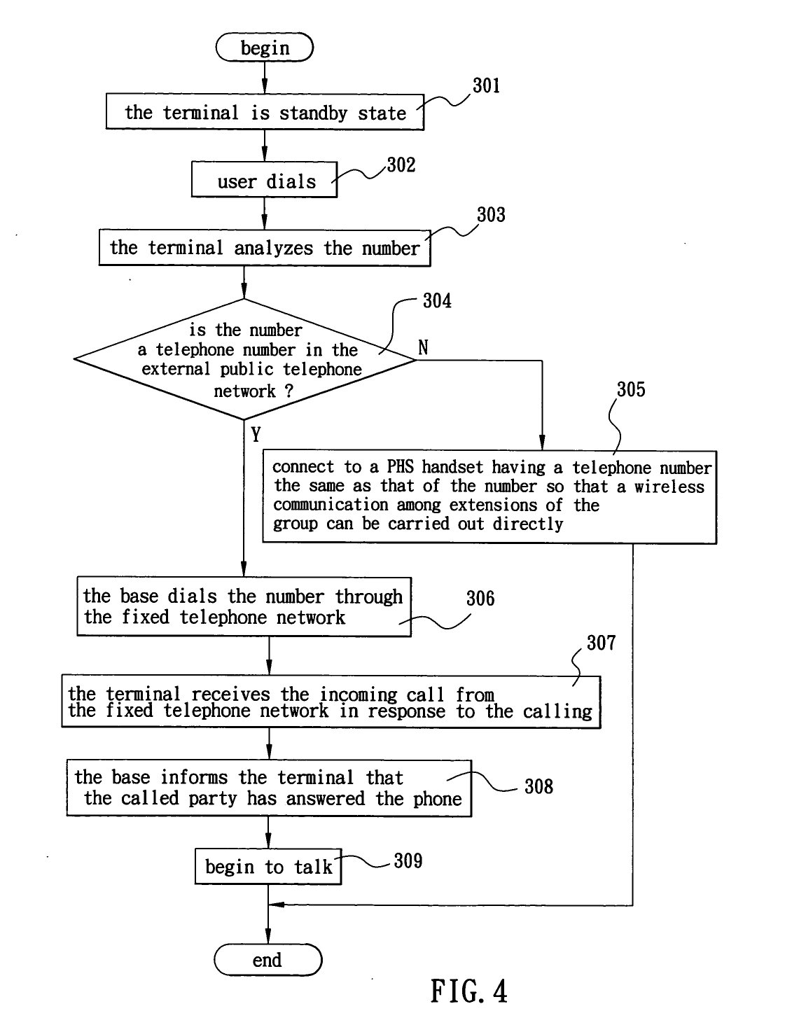

(ii) Details of the terminal calling a telephone number in the external public telephone network via the base are illustrated in the flow chart of FIG. 4.

In step 301, the terminal is in a standby state.

In step 302, a user dials a number.

In step 303, the terminal analyzes the number.

In step 304, it is determined whether the number is a telephone number in the external public telephone network. If yes, the process jumps to step 306. Otherwise, the process goes to step 305.

In step 305, connect to a PHS handset having a telephone number the same as that of the called number so that a wireless communication among extensions of the group can be carried out directly.

In step 306, the base dials the called number through the fixed telephone network (e.g., PSTN) prior to calling.

In step 307, the terminal receives the incoming call from the fixed telephone network (e.g., PSTN) in response to the calling.

In step 308, the base informs the terminal that the called party has answered the telephone.

In step 309, begin to talk over the telephone.

In the invention on hook can be made by either the called party or the terminal as detailed in the following flow charts.

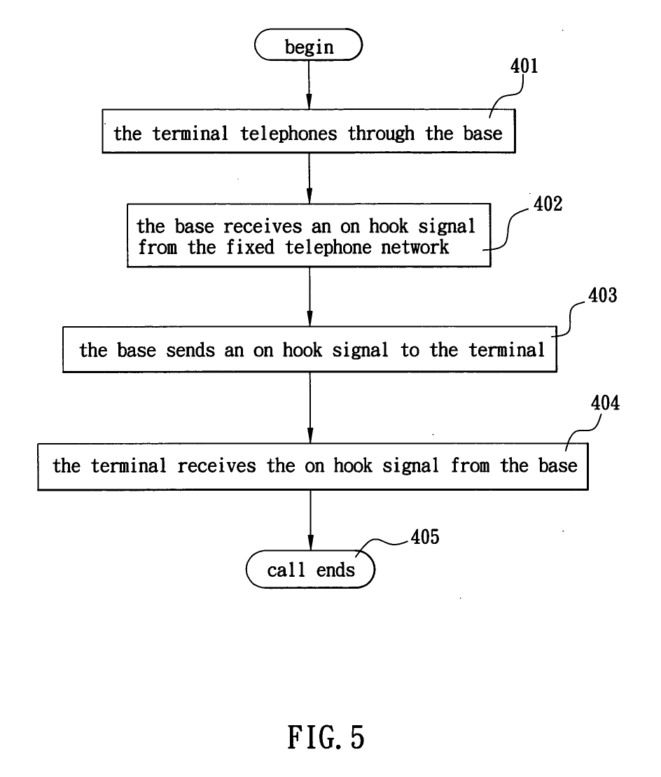

(i) Details of ending a call by a called party are illustrated in the flow chart of FIG. 5.

In step 401, the terminal talks to a person through the base.

In step 402, the base receives an on hook signal from the fixed telephone network (e.g., PSTN).

In step 403, the base sends an on hook signal to the terminal.

In step 404, the terminal receives the on hook signal from the base.

In step 405, call ends.

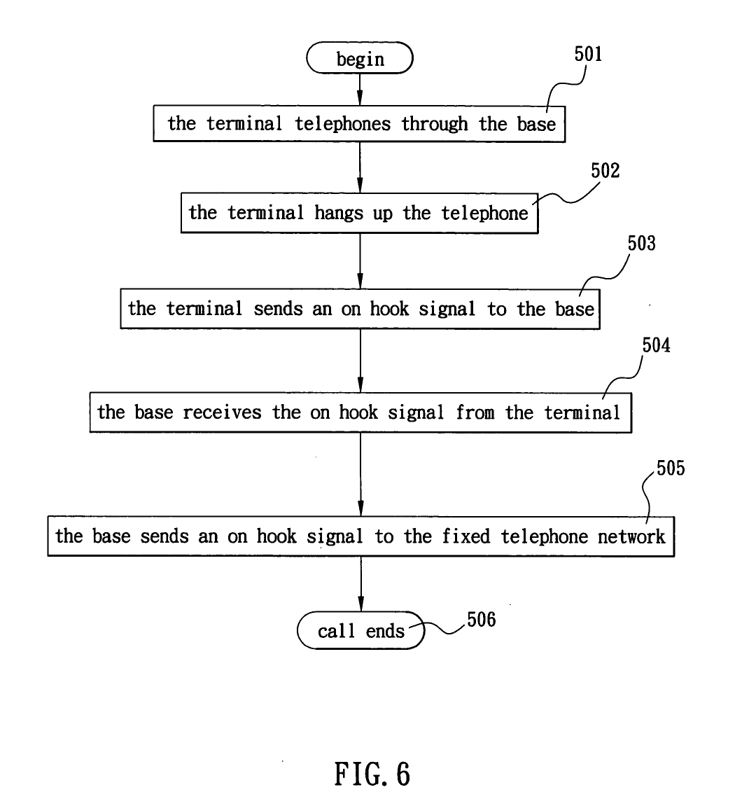

(ii) Details of ending a call by a terminal are illustrated in the flow chart of FIG. 6.

In step 501, the terminal talks to a person through the base.

In step 502, the terminal hangs up the telephone.

In step 503, the terminal sends an on hook signal to the base.

In step 504, the base receives the on hook signal from the terminal.

In step 505, the base sends an on hook signal to the fixed telephone network (e.g., PSTN).

In step 506, call ends.

While the invention has been described by means of specific embodiments, numerous modifications and variations could be made thereto by those skilled in the art without departing from the scope and spirit of the invention set forth in the claims.

What is claimed is:

1. An apparatus for improving communication quality of low power cellular phone, comprising:
at least one fixed telephone each coupled to a fixed public switched telephone network via a telephone line and including a wireless communication exchange module; and
at least one low power cellular phone each being adapted to either use the adjacent fixed telephone as a CS for communicating with another low power cellular phone or high power cellular phone via the fixed telephone or communicate through connections among other twisted pair telephones when the low power cellular phone is not able to communicate wirelessly in one of a plurality of circumstances.

2. The apparatus of claim 1, wherein the fixed telephone is an indoor personal telephone.

3. The apparatus of claim 1, wherein the fixed telephone is an indoor public telephone.

4. The apparatus of claim 1, wherein the fixed telephone is an outdoor public telephone.

5. A method of improving communication quality of low power cellular phone implemented in a fixed public switched exchange telephone network wherein each of a plurality of fixed telephones is coupled to a fixed telephone network and has a wireless communication exchange module in cooperation with one of a plurality of low power cellular phones, the method comprising the steps of:
using each fixed telephone as a low power cellular phone and a base;
using each low power cellular phone as a terminal;
commanding one terminal to communicate with other terminals via a wireless channel and connect to the wireless communication exchange module of the fixed telephone; and
using each fixed telephone as means for communicating with the low power cellular phones, a high power cellular phone, or other twisted pair telephones for communication.

6. The method of claim 5, wherein a group is established between the base and each terminal by performing operations comprising:
commanding the base to issue a transmission request to the terminal prior to establishing the group;
commanding the terminal to issue a registration request to the base prior to establishing the group;
commanding the base to store terminal data including a plurality of telephone numbers in an external public telephone network; and
establishing the group wherein the base is served as a main telephone and the terminal is served as an extension.

7. The method of claim 6, wherein an incoming call is transferred from the base to the terminal by performing operations comprising:
commanding the base to be in a standby state;
commanding the base to receive the incoming call from the fixed telephone network;
commanding the base to analyze the incoming call to find out the called number and know a message contained therein;
comparing the called number with the telephone numbers in the external public telephone network;
if the comparison is positive commanding the base to inform the terminal of the incoming call from the extension and inform one of the low power cellular phones having the same telephone number as the called number of the incoming call;
commanding the terminal to receive the incoming call from the extension;
commanding the terminal to answer the telephone and and commanding the terminal to send a signal about a connection between the extensions;
commanding the base to inform the fixed telephone network of the incoming call; and
talking over the telephone.

8. The method of claim 7, wherein in response to the result of comparing the called number with the telephone numbers in the external public telephone network being negative, the base rings so that the base is adapted to be informed of the incoming call.

9. The method of claim 6, wherein the terminal calls one of the telephone numbers in the external public telephone network via the base by performing operations comprising:
commanding the terminal to be in a standby state;
dialing a number of the terminal;
commanding the terminal to analyze the number;
determining whether the number is one of the telephone numbers in the external public telephone network;
if the determination is positive commanding the base to dial the number through the fixed telephone network prior to calling;
commanding the terminal to receive the incoming call from the fixed telephone network in response to the calling;
commanding the base to inform the terminal that a called party has answered the telephone; and
talking over the telephone.

10. The method of claim 9, wherein in response to the result of determining whether the number is one of the telephone numbers in the external public telephone network being negative, connect to one of the low power cellular phones having a telephone number the same as that of the number so that a wireless communication among the extensions of the group is adapted to carry out directly.
